(19) United States
(12) Patent Application Publication
(10) Pub. No.: US 2026/0074404 A1
(43) Pub. Date: Mar. 12, 2026

(54) DOUBLE-SEALED BATTERY TOP COVER ASSEMBLY

(71) Applicant: Ningbo Zhenyu Auto Parts Co., Ltd., Ningbo City (CN)

(72) Inventors: Liang'en Wu, Ningbo City (CN); Jiben Tan, Ningbo City (CN); Jiahui Xu, Ningbo City (CN); Shuai Li, Ningbo City (CN)

(21) Appl. No.: 19/394,538

(22) Filed: Nov. 19, 2025

(30) Foreign Application Priority Data
Jun. 9, 2025 (CN) 202521177615.1

(51) Int. Cl. H01M 50/636; H01M 50/15; H01M 50/176; H01M 50/188; H01M 50/55; H01M 50/553

(52) U.S. Cl. CPC H01M 50/636; H01M 50/15; H01M 50/176; H01M 50/188; H01M 50/55; H01M 50/553

(57) ABSTRACT

A double-sealed battery top cover assembly, which includes an upper cover, a terminal post, a sealing ring, an upper insulating part, a riveting block, and a sealant. The bottom of the terminal post is provided with a mounting plate, the upper insulating part is arranged between the upper cover and the riveting block, the upper insulating part is provided with a flow guiding groove communicated with a clearance space, the riveting block is provided with a filling port communicated with the flow guiding groove, and the sealant and the sealing ring form a double seal for the clearance space. Through a double seal function of the sealing ring and the sealant, electrolyte leakage in a short-circuit test is avoided.

### TECHNICAL FIELD

The present disclosure relates to the technical field of batteries, and particularly, to a double-sealed battery top cover assembly.

### BACKGROUND

Currently, lithium battery top cover structures on the market are typically provided with sealing rings to prevent electrolyte leakage. The sealing rings are generally made of fluoroelastomer. In the production process, lithium batteries are subjected to a short-circuit test, that is, terminal posts are short-circuited for approximately 10 minutes. This operation generates high temperature of about 500° C., which causes the fluoroelastomer sealing rings to be burnt and results in seal failure. Therefore, how to prevent the sealing rings from being burnt in the short-circuit test for the terminal posts is a significant technical problem in this field.

### SUMMARY

An objective of the present disclosure is to provide a double-sealed battery top cover assembly to solve the above technical shortcomings.

The present disclosure provides a double-sealed battery top cover assembly, which includes: an upper cover, the upper cover being provided with a mounting hole; a terminal post, the bottom of the terminal post being provided with a mounting plate, the terminal post being inserted in the mounting hole, and the mounting plate being assembled under the upper cover; a sealing ring, which is arranged between the upper cover and the mounting plate; an upper insulating part, the upper insulating part being provided with a sleeving hole sleeving the terminal post; a riveting block, which is arranged above the terminal post, the upper insulating part being arranged between the upper cover and the riveting block; and a sealant, which is arranged in a clearance space formed among the mounting hole, the sealing ring, and the terminal post, and where the edge of the sleeving hole is bent downwards, the upper insulating part is provided with a flow guiding groove communicated with the clearance space, the riveting block is provided with a filling port communicated with the flow guiding groove, and the sealant is formed in the clearance space through the filling port and the flow guiding groove; and the sealant and the sealing ring form a double seal for the clearance space.

The technical effects of the present disclosure are as follows: the clearance space is formed among the mounting hole of the upper cover, the sealing ring, and the terminal post, the high temperature resistant sealant is injected to the positions of the sealing ring and the upper insulating part, the sealant is naturally solidified and positioned in the clearance space and covers the top surface of the sealing ring, and due to high temperature resistance of the sealant, although the sealing ring is burnt through high temperature generated when the terminal post is short-circuited, the sealant at this moment plays a sealing role, to ensure that the battery top cover assembly is free of electrolyte leakage, and the problem of electrolyte leakage of the battery top cover assembly in a short-circuit test is solved through a double seal function of the sealing ring and the sealant.

### BRIEF DESCRIPTION OF THE DRAWINGS

FIG. 1 is a three-dimensional diagram of a whole structure when a terminal post is a negative terminal post;

FIG. 2 is a top view of a whole structure when a terminal post is a negative terminal post;

FIG. 3 is a structural sectional view in a B-B direction in FIG. 2;

FIG. 4 is an exploded view of a whole structure when a terminal post is a negative terminal post;

FIG. 5 is a three-dimensional diagram of a whole structure when a terminal post is a positive terminal post; and

FIG. 6 is an exploded view of a whole structure when a terminal post is a positive terminal post.

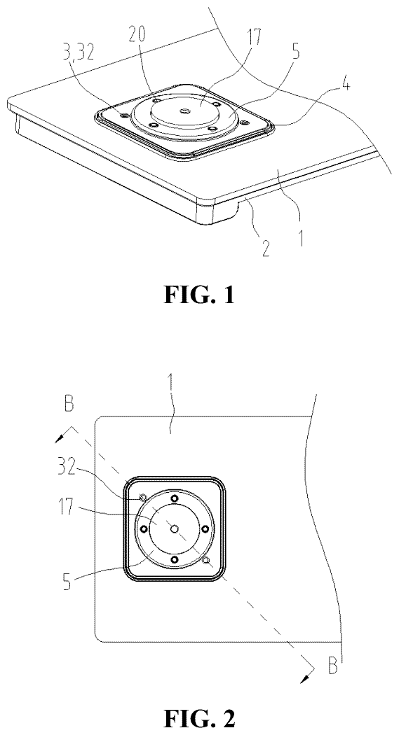

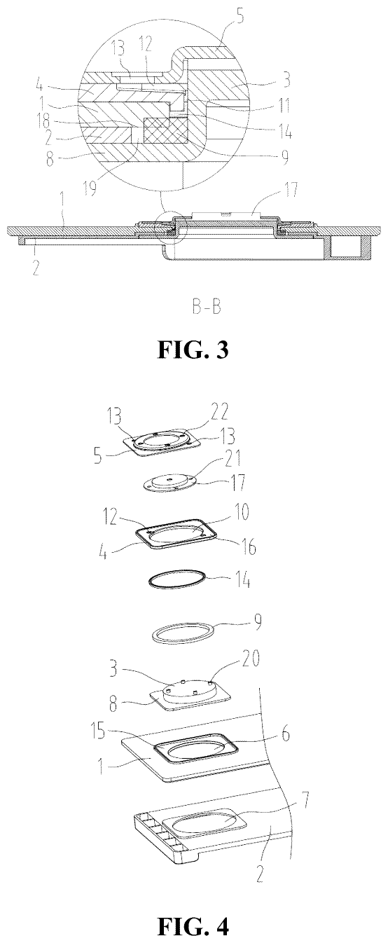

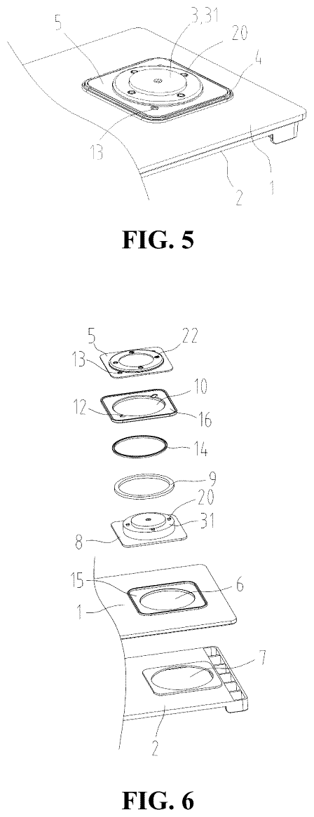

Reference numerals: 1: upper cover; 2: lower plastic plate; 3: terminal post; 31: positive terminal post; 32: negative terminal post; 4: upper insulating part; 5: riveting block; 6: mounting hole; 7: sealing hole; 8: mounting plate; 9: sealing ring; 10: sleeving hole; 11: clearance space; 12: flow guiding groove; 13: filling port; 14: sealant; 15: first mounting groove; 16: second mounting groove; 17: current-carrying block; 18: step surface; 19: buffer space; 20: convex post; 21: positioning hole; and 22: riveting hole.

### DESCRIPTION OF THE EMBODIMENTS

The technical solutions in the embodiments of the present disclosure will be clearly and completely described below with reference to the drawings in the embodiments of the present disclosure. It is apparent that the described embodiments are not all embodiments but only part of the embodiments of the present disclosure. All other embodiments obtained by those of ordinary skill in the art on the basis of the embodiments in the present disclosure shall fall within the scope of protection of the present disclosure.

A double-sealed battery top cover assembly of the present disclosure includes an upper cover 1, a lower plastic plate 2, a terminal post 3, an upper insulating part 4, and a riveting block 5. The upper cover 1 is provided with a mounting hole 6, the lower plastic plate 2 is provided with a sealing hole 7 coaxial with the mounting hole 6, the upper cover 1 and the lower plastic plate 2 are both of a rectangular plate structure, the upper cover 1 and the lower plastic plate 2 are fitted with each other vertically, the top of the terminal post 3 sequentially passes through the sealing hole 7 and the mounting hole 6 and is inserted in the mounting hole 6, the bottom of the terminal post 3 is provided with a mounting plate 8, the bottom surface of the lower plastic plate 2 is provided with a countersink coaxial with the sealing hole, and the mounting plate 8 is fitted in the countersink of the lower plastic plate 2, such that the mounting plate 8 is flush with the bottom surface of the lower plastic plate 2.

A sealing ring 9 is arranged between the upper cover 1 and the terminal post 3, a bending angle between the mounting plate 8 and the terminal post 3 is ninety degrees, the sealing ring 9 is sleeved on the bend, the riveting block 5 is provided with a through hole and sleeved on the terminal post 3 through the through hole, the upper insulating part 4 is provided with a sleeving hole 10, sleeved on the terminal post 3 through the sleeving hole 10, and positioned between the terminal post 3 and the riveting block 5, a clearance space 11 is formed among the inner wall of the mounting hole 6, the top surface of the sealing ring 9, and the outer wall of the terminal post 3, the edge of the sleeving hole 10 of the upper insulating part 4 is bent downwards, stretches into the clearance space 11, and extends to a position above the sealing ring 9, the surface of the upper insulating part 4 is provided with a flow guiding groove 12 communicated with the clearance space 11, the upper cover 1 is provided with a filling port 13 at the location of the flow guiding groove 12, which is communicated with the flow guiding groove 12, the filling port 13 is positioned right above the flow guiding groove 12, a sealant 14 is filled through the filling port 13, and the sealant 14 flows along the flow guiding groove 12 into the clearance space 11 to fill the clearance space 11, so as to cover the top surface of the sealing ring 9 in the clearance space 11; and when the sealant 14 is solidified in the clearance space 11 and forms a seal, and the seal of the sealing ring 9 is combined, the sealant 14 and the sealing ring 9 form a double seal for the clearance space 11, and the sealant 14 covers and protects the sealing ring 9.

Further, the bottom surface of the flow guiding groove 12 is arranged obliquely, that is, the flow guiding groove 12 is inclined toward the clearance space 11, such that the sealant 14 can naturally flow into the clearance space 11.

Further, the surface of the upper insulating part 4 is provided with at least two flow guiding grooves 12, the at least two flow guiding grooves 12 are distributed symmetrically or circumferentially along the central axis of the sleeving hole 10, filling ports 13 and the flow guiding grooves 12 are arranged in one-to-one correspondence, and the sealant 14 is filled through the filling ports 13, such that the clearance space 11 is quickly filled with the sealant 14.

Further, the surface of the upper cover 1 is provided with a first mounting groove 15, the mounting hole 6 is formed in the center of the first mounting groove 15, and the upper insulating part 4 is embedded in the first mounting groove 15, that is, the first mounting groove 15 limits the upper insulating part 4.

Further, the surface of the upper insulating part 4 is provided with a second mounting groove 16, the sleeving hole 10 is formed in the second mounting groove 16, and the riveting block 5 is embedded in the second mounting groove 16.

The terminal post 3 includes a positive terminal post 31 and a negative terminal post 32. The positive terminal post 31 is made of an aluminum alloy, and the negative terminal post 32 is made of a copper-aluminum alloy. In the embodiment, a number of mounting holes is two, and the two mounting holes are respectively configured to mount the positive terminal post 31 and the negative terminal post 32.

Specifically, a current-carrying block 17 is arranged between the top of the negative terminal post 32 and the riveting block 5, that is, the substrate portion of the negative terminal post 32 is made of copper, the current-carrying block 17 is made of aluminum, the substrate portion of the negative terminal post 32 and the current-carrying block 17, that is, the copper and the aluminum, are connected in a welding manner, the riveting block 5 is sleeved on the current-carrying block 17 through the through hole, the current-carrying block 17 is provided with convex posts 20, the riveting block 5 is provided with riveting holes 22, and the convex posts 20 are inserted into the riveting holes 22 to achieve riveting through a press riveting process.

That is, the positive terminal post 31 is entirely made of the aluminum alloy, and the negative terminal post 32 includes an upper part and a lower part, where the upper part is the current-carrying block 17, and the lower part is the substrate portion made of copper.

Further, the internal diameter of the sealing hole 7 is greater than that of the mounting hole 6, such that a step surface 18 is formed between the upper cover 1 and the lower plastic plate 2; and a buffer space 19 for accommodating deformation of the sealing ring 9 is formed between the step surface 18 and the mounting plate 8, such that the sealing ring 9 is preferably positioned and mounted.

Further, the top of the terminal post 3, that is, the tops of the positive terminal post 31 and the negative terminal post 32 are provided with convex posts 20, the current-carrying block 17 of the negative terminal post 32 and the riveting block 5 are sequentially provided with coaxially penetrating positioning holes 21 and riveting holes 22, the convex posts 20 pass through the positioning holes 21 and the riveting holes 22, and the convex posts 20 and the riveting holes 22 are riveted through the press riveting process, that is, the riveting block 5, the current-carrying block 17, and the terminal post 3 are riveted; and the convex posts 20 on the top of the positive terminal post 31 and the riveting holes 22 are riveted directly through press riveting.

Further, the sealant 14 is a high temperature resistant sealant, such as a dual-component adhesive.

The present disclosure is not limited to the above optimal embodiment, and in light of the present disclosure, those skilled in the art may derive various other forms of products. However, regardless of any modifications in shape or structure, any technical solution that achieves substantial equivalence or similarity to the present disclosure shall fall within the scope of protection of the present disclosure.

What is claimed is:

1. A double-sealed battery top cover assembly, comprising:
an upper cover, the upper cover being provided with a mounting hole;
a terminal post, the bottom of the terminal post being provided with a mounting plate, the terminal post being inserted in the mounting hole, and the mounting plate being assembled under the upper cover;
a sealing ring, which is arranged between the upper cover and the mounting plate;
an upper insulating part, the upper insulating part being provided with a sleeving hole sleeving the terminal post;
a riveting block, which is arranged above the terminal post, the upper insulating part being arranged between the upper cover and the riveting block; and
a sealant, which is arranged in a clearance space formed among the mounting hole, the sealing ring, and the terminal post, and
wherein the edge of the sleeving hole is bent downwards, the upper insulating part is provided with a flow guiding groove communicated with the clearance space, the riveting block is provided with a filling port communicated with the flow guiding groove, and the sealant is formed in the clearance space through the filling port and the flow guiding groove; and
the sealant and the sealing ring form a double seal for the clearance space.

2. The double-sealed battery top cover assembly according to claim 1, wherein the bottom surface of the flow guiding groove is arranged obliquely.

3. The double-sealed battery top cover assembly according to claim 2, wherein the surface of the upper insulating part is provided with at least two flow guiding grooves, and filling ports and the flow guiding grooves are arranged in one-to-one correspondence.

4. The double-sealed battery top cover assembly according to claim 1, wherein the surface of the upper cover is provided with a first mounting groove, the mounting hole is positioned in the first mounting groove, and the upper insulating part is assembled in the first mounting groove.

5. The double-sealed battery top cover assembly according to claim 3, wherein the surface of the upper insulating part is provided with a second mounting groove, the sleeving hole is formed in the second mounting groove, and the riveting block is assembled in the second mounting groove.

6. The double-sealed battery top cover assembly according to claim 1, wherein the terminal post comprises a positive terminal post and a negative terminal post, a number of mounting holes is two, and the two mounting holes are respectively configured to mount the positive terminal post and the negative terminal post.

7. The double-sealed battery top cover assembly according to claim 6, wherein a current-carrying block is arranged between the top of the negative terminal post and the riveting block, and the riveting block is sleeved on the current-carrying block.

8. The double-sealed battery top cover assembly according to claim 1, further comprising a lower plastic plate, wherein the lower plastic plate is provided with a sealing hole, the terminal post passes through the sealing hole and is inserted in the mounting hole, the internal diameter of the sealing hole is greater than that of the mounting hole to form a step surface between the upper cover and the lower plastic plate, and a buffer space for accommodating deformation of the sealing ring is formed between the step surface and the mounting plate.

9. The double-sealed battery top cover assembly according to claim 7, wherein the tops of the negative terminal post and the positive terminal post are provided with convex posts, the current-carrying block of the negative terminal post and the riveting block are respectively provided with positioning holes and riveting holes, the convex posts sequentially pass through the positioning holes and the riveting holes and are riveted with the riveting block; and the convex posts on the top of the positive terminal post pass through the riveting holes of the riveting block and are riveted with the riveting block.

10. The double-sealed battery top cover assembly according to claim 2, wherein the sealant is a high temperature resistant sealant.
